(19) United States
(12) Patent Application Publication
(10) Pub. No.: US 2018/0347414 A1
(43) Pub. Date: Dec. 6, 2018

(54) COOLED VALVE FOR INTERNAL COMBUSTION ENGINES HAVING A LOAD RELIEF GROOVE

(71) Applicant: FEDERAL-MOGUL VALVETRAIN GMBH, BARSINGHAUSEN (DE)

(72) Inventors: STEFAN KELLERMANN, BARSINGHAUSEN (DE); GUIDO BAYARD, DORTMUND (DE)

(21) Appl. No.: 15/761,643

(22) PCT Filed: Jul. 11, 2016
(86) PCT No.: PCT/EP2016/066408

§ 371 Date: Mar. 20, 2018

(30) Foreign Application Priority Data
Sep. 22, 2015 (DE) 102015116010.2

(51) Int. Cl. F01L 3/14; F01P 3/14; F01L 3/20; F16K 49/00; F16K 15/02

(52) U.S. Cl. CPC F01L 3/14; F01P 3/14; F16K 15/023; F16K 49/005; F01L 3/20

(57) ABSTRACT

The invention relates to a cooled inlet or outlet valve (4) for internal combustion engines, comprising a valve disc (6), a valve stem (8), and a hollow space (10) inside the valve stem (8) and the valve disc (6). A coolant (12) is arranged in the hollow space (10). The valve is designed comprising at least two parts and has on a valve disc surface (22) an opening (18) which is closed by a cover (20), wherein the cover (20) is additionally provided with at least one relief groove (34) which relieves a joint (32) between the opening (18) in the valve disc surface (22) and the cover (20).

The present invention relates to cooled valves for internal combustion engines. In particular, the present invention relates to a sodium-cooled outlet valve for an internal combustion engine which has an increased service life compared with similar valves in the prior art.

Internally cooled or sodium-cooled exhaust valves were known as early as 1935.

Sodium cooling and its effects are well known in the prior art, and technical developments of recent years have primarily been concerned with enlarging the coolant volume in the region of the valve disk and simplified manufacturing processes in order to be able to produce sodium-cooled valves more cheaply.

However, a need exists for improving the service life of internally cooled valves, to further reduce the risk of valve disk or stem breakage. In addition, there is a need for internally cooled valves which have improved cooling properties.

In accordance with the present invention, a cooled or internally cooled valve is provided for internal combustion engines, having a valve disk, a valve stem, as well as a cavity within the valve stem and the valve disk, and with a coolant which is disposed in the cavity. The coolant only partially fills the cavity and can move in the cavity. The valve is constructed in at least two pieces and is provided with an opening on a valve disk face which is closed with a cover. The cover is provided with at least one relief groove which relieves a joint between the opening of the valve disk face and the cover. The relief is brought about by an increased elasticity in an annular region close to the edge of the cover. The cover can deform concavely or convexly under the pressure of the combustion gases or under thermal load because of the increased elasticity. Upon a concave or convex deformation of the cover, this bending load is no longer transferred to the joint between the cover and valve disk, but results in bending in the region of the relief groove.

Essentially, a joint or a junction between the cover and valve disk is relieved by thinning the material of the cover.

The valve is constructed in at least two parts and has an opening on the valve disk face which is closed with a cover. The cover is connected to the valve disk face by joining. The cover can be securely connected to the disk by laser welding, electron beam welding, resistance welding or friction welding.

When the relief groove is disposed on the side of the cavity, this also acts to increase the internal cavity surface area for contact with the liquid coolant or sodium filling.

In one exemplary embodiment of the present invention, sodium is used as the coolant. However, other alkali or alkaline-earth metals or alloys with a sufficiently low melting point may also be used.

In a further exemplary embodiment of the present invention, the at least one relief groove in the cover is disposed around a valve axis in a circle. The relief groove in this embodiment is disposed on the inside or in the cavity of the valve. Because the thickness of the material of the cover is reduced, the relief groove increases the elasticity of the cover in a circular region in from the edge of the cover. Furthermore, the relief groove increases the surface area of the cavity and thus the contact surface with the coolant, whereupon the heat transfer from the cover or the base of the valve to the coolant can be improved.

In a further exemplary embodiment of the present invention, the at least one relief groove is disposed on an outside of the cover in the region of the disk face of the valve. A relief groove disposed in this position suffers from the disadvantage that it increases the surface area of the combustion chamber and thus increases the transfer of heat from combustion gases to the valve disk. At the same time, however, a relief groove on the outside in combination with a relief groove on the inside can significantly increase the elasticity compared with a single relief groove. Furthermore, a plurality of concentric relief grooves may be formed on the outside.

In an additional exemplary embodiment of the valve of the present invention, the centre of the cover is provided with a pyramidal or conical structure to guide the coolant in a radial direction of the valve disk. The conical structure may have the form of a parabolic cone, and reduces the impact force of the coolant on the cover in a manner such that the coolant is gently diverted instead of impinging upon a face which extends perpendicular to the direction of movement of the coolant. A structure may be in the form of a face which resembles a Flamm's paraboloid to reduce the load for a joint of the cover upon impact of the sodium, and thus to increase the service life of the valve. The Flamm's paraboloid is simply a special case of a parabolic cone, which may also be used here in order to prevent a downwardly flowing stream of sodium from exerting a large force on the cover and thus on a joint of the cover.

In a further exemplary embodiment of the present invention, a relief groove on the inside merges directly into the conical structure in the centre. This embodiment diverts a coolant moving downwards in the direction of the valve disk initially from the centre in the direction of the edge of the valve disk. Before the coolant reaches the edge, it flows into the relief groove, and when it flows out of the relief groove, it is diverted upwards again in the direction of the rear side of the valve disk. In this manner, by cooperation of the conical structure and the relief groove, the flow in the cavity can be reversed in the region of the edge of the valve disk. The coolant can be guided along the rear side of the valve disk, whereupon cooling of the valve can be further improved. It is also possible that in the region of the valve disk edge, a type of “vortex ring” or toroidal vortex is formed, i.e. a toroidal flow which can cool the edge of the valve disk particularly well.

In a further exemplary embodiment of the valve of the present invention, a relief groove has a cross-section which guides radially outwardly flowing coolant in the direction of a rear side of the valve disk. This relief groove is disposed on the inside of the cavity and is provided with a steeply inclined outer flank which merges with a rounding in the base of the groove. Sodium flowing in a thin layer can flow directly from the flow cone or from the conical structure into the relief groove and from there is guided in the direction of the rear side of the valve disk. Depending on the shape of the cavity in the region of the rear side of the valve disk, a reverse flow in the direction of the valve axis or a toroidal vortex ring flow may be produced. The vortex ring flow then rotates in a plane which passes through the valve axis. In this manner, the sodium not only sloshes backwards and forwards between the hot and the cold side of the valve, but also is urged by the conical structure and the shape of the relief groove into a flow pattern which can further improve the transport of heat.

Ideally, the cover which is welded to the valve disk face as well as the structures on it such as the relief groove(s) and the conical structure may be designed in a manner such that it can be forged using conventional processes in order to keep the manufacturing costs, and thus the cost of the valve, as low as possible.

A joint between the opening of the valve disk face and the cover is relieved by means of the cover with the at least one relief groove. The relief groove is positioned close to the joint on the inside and/or outside of the cover. The relief groove reduces the material thickness of the cover and endows it with an increased elasticity, which again reduces the load on the joint between the cover and valve disk. In total, a cover which is rendered flexible because of a conical structure can be rendered more elastic again, so that when the cover is loaded, only a portion of the forces is transmitted onto the joint. In total, the grooves can take up a portion of the load and thus reduce a load on the joint and thereby increase the overall service life of the internally cooled valve. Preferably, two relief grooves are employed on both the inside and outside in order to obtain a maximum elasticity for the cover. The disposition of the relief grooves can produce a kind of corrugation by means of which an elastic connection can be produced between the centre of the cover and the edge of the cover. Because of the relief grooves, a deflection of the cover inwards or outwards relieves the joint, whereupon failure of the joint can be delayed or prevented. The cover and the valve disk may be joined by laser welding, electron beam welding, resistance welding or friction welding.

In a further exemplary embodiment of the valve of the present invention, the depth of the at least one relief groove is such that it corresponds to at least one third of a local height or material thickness of the cover and at most two thirds of the local height or material thickness of the cover. This therefore defines the fact that the relief groove produces a substantial reduction in the material thickness of the cover which also produces a substantial increase in the elasticity of the cover in the region of the relief groove.

In a further exemplary embodiment of the valve of the present invention, in the region of the at least one relief groove, the cover has a material thickness which is reduced by one quarter to three quarters, preferably one third to two thirds and more preferably by two fifths to three fifths. This material thickness also applies to positions at which a plurality of relief grooves are disposed. This relatively large reduction in the material thickness produces a kind of elastic or foil hinge in the region of the relief grooves which can keep bending forces on the cover away from the joint of the cover.

The present invention will now be described in more detail with reference to the accompanying drawings. The figures are provided by way of illustration only.

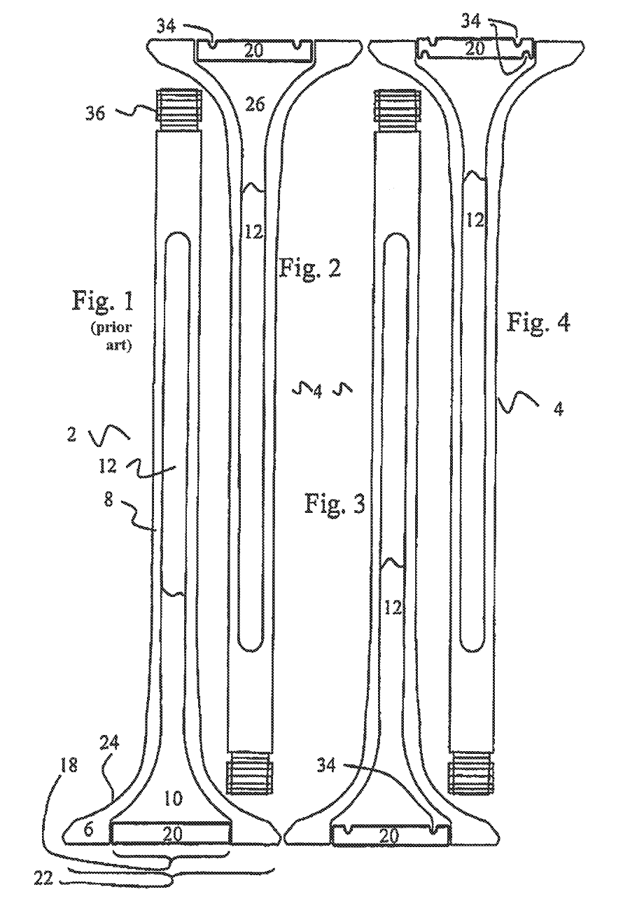

FIG. 1 shows a conventional internally cooled valve.

FIG. 1A shows a cover for a conventional internally cooled valve.

FIG. 2 shows an internally cooled valve in accordance with the invention with a relief groove on a valve disk.

FIG. 2A shows a cover for an internally cooled valve in accordance with the invention with a relief groove on the valve disk.

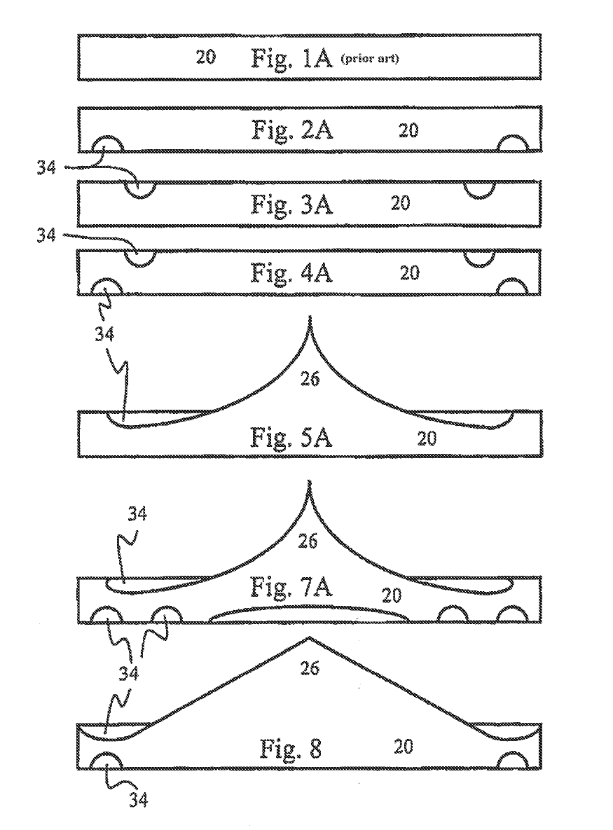

FIG. 3 shows an internally cooled valve in accordance with the invention with a relief groove on the cavity side.

FIG. 3A shows a cover for an internally cooled valve in accordance with the invention with a relief groove on the valve disk.

FIG. 4 shows an internally cooled valve in accordance with the invention with two relief grooves, wherein one is on the valve disk and one is on the cavity side.

FIG. 4A shows a cover for an internally cooled valve in accordance with the invention with the two relief grooves of FIG. 4.

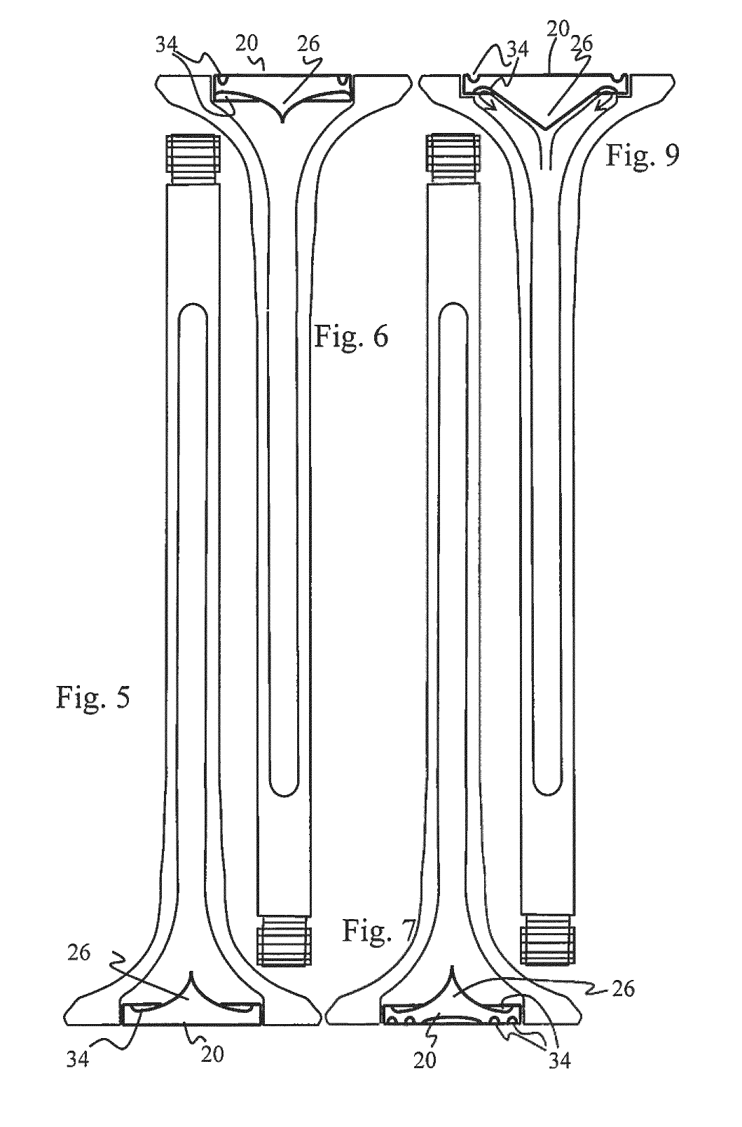

FIG. 5 shows an internally cooled valve in accordance with the invention with a relief groove which merges directly into a conical structure.

FIG. 5A shows a cover for an internally cooled valve in accordance with the invention with the conical structure which merges into an internally disposed relief groove as shown in FIG. 5.

FIG. 6 shows an internally cooled valve in accordance with the invention with a relief groove which merges directly into a conical structure, and a further externally disposed relief groove.

FIG. 7 shows an internally cooled valve in accordance with the invention with a total of three relief grooves and one conical structure.

FIG. 7A shows the cover for the valve of FIG. 5.

FIG. 8 shows a cover with a total of two relief grooves and one conical structure.

FIG. 9 shows an internally cooled valve in accordance with the invention with a total of two relief grooves and one conical structure.

In both the description and in the figures, identical or similar reference numerals are used to define identical or similar components and elements. In order to keep the description as clear and concise as possible, elements which have already been described in one figure are not specifically described in further figures, in order to avoid redundancy.

FIG. 1 shows a conventional internally cooled valve 2 with a valve stem 8 the lower end of which spreads out into a valve disk 6. The upper end of the valve stem 6 ends in a stem end 36 from which the valve is usually controlled. The interior of the valve is provided with a cavity 10 which is filled with a coolant 12. The usual coolant is sodium, which is in the liquid state at the operating temperatures of an internal combustion engine. Usually, only ⅔ to ¾ of the cavity of the valve is filled with sodium, rather than the entire cavity. It is also possible to fill only ¼ or ⅓ of the cavity of the valve with sodium. In operation, the sodium in the valve stem 8 or in the cavity 10 of the valve stem 3 moves up and down, and in so doing transports heat from the valve disk 6 in the direction of the cooled valve stem 8. Thus, upon each opening and closing operation, the sodium moves inside the valve 2. The cavity 10 in the valve 2 has been produced in a manner such that the valve disk 6 is provided with an opening 18 at the valve disk face 22. The cavity 10 in the valve disk 6 and the valve stem 8 has been formed through the opening 18. After filling with the sodium coolant 12, the opening 18 has been sealed using a cover 20. The cover has been connected to the valve disk by laser welding, electron beam welding or resistance welding. The rear side of the valve disk 24 in this embodiment does not have any joints and the valve disk may be produced in one piece with the valve stem, so that any risk of the valve disk breaking off can be minimized.

FIG. 1A shows a cover for a conventional internally cooled valve which is a simple metal disk.

FIG. 2 shows an internally cooled valve in accordance with the invention with a relief groove on the valve disk. In FIG. 2, as was the case for the valve of FIG. 1, the valve 4 in accordance with the invention is provided with an opening in the valve disk which is closed with a cover 20. The cover 20 is provided with a circumferential relief groove 34 with a round profile. The relief groove 34 locally reduces the material thickness of the cover 20 so that upon a deflection of the cover, this deflection produces smaller forces at a joint of the cover with the edge of the opening. When the cover is bowed inwardly by the combustion gases during a combustion process, the edge of the cover can deform in the region of the relief groove. Because of this, the joint has to accommodate a smaller load and thus has a longer service life. Even when cold coolant from the valve stem cools the inside of the cover, the latter is slightly convexly deformed. A deformation of this type too is no longer transmitted as strongly to the Joint between the cover and valve disk because of the relief groove. In addition, coolant which impinges on the cover when the cover is opened transmits a force to the cover which can contribute to a deformation of the cover.

FIG. 2A shows the cover of FIG. 2 in a sectional view. Here, the relief groove 34 is disposed on the bottom of the cover 20.

FIG. 3 shows a further internally cooled valve in. accordance with the invention, with a relief groove on the inside of the cover, and thus in the cavity of the valve. In FIG. 3, as was the case for the valve of FIG. 1, the valve 4 in accordance with the invention is provided with an opening in the valve disk which is closed with a cover 20. The cover 20 is provided with a circumferential relief groove 34 with a round profile which here, however, is on the inside, thereby enlarging the surface area of the cavity, leading to improved heat transfer from the cover to the coolant. Here again, the relief groove 34, locally reduces the material thickness of the cover 20, and thus a deflection of the cover will produce smaller forces on a joint of the cover with the edge of the opening. The reasons for a deflection of the cover have already been discussed in relation to FIG. 2 and will therefore not be reiterated here.

FIG. 3A shows the cover of FIG. 3 in a sectional view. Here, the relief groove 34 is disposed on the top of the cover 20.

FIG. 4 shows a sectional view through an internally cooled valve in accordance with the invention. In FIG. 4, two relief grooves 34 are provided on the cover 20. One relief groove is on the side of the valve disk or the outside, and one relief groove 34 is disposed in a manner such that it lies in the cavity of the internally cooled valve. Both relief grooves 34 reduce the material thickness of the cover 20 near its edge. Because of the relief grooves, the cover can deflect more easily even when the edge of the cover is immobilized by a joint.

When a conventional cover is deflected slightly due to an increase in pressure in the combustion chamber or because of a temperature difference in the valve, much higher forces act on a joint between the cover and valve disk. These forces could be sufficient to overload and destroy a laser welded seam, electron beam welded seam or a resistance welded seam between the cover and the valve disk.

By means of the relief grooves, the edge region of the cover can be configured so as to be more elastic. When the cover is deflected inwardly, the edge region can deflect and the load on the joint at the edge is substantially reduced. The degree of relief on the joint brought about by the relief grooves depends on their depth and width. Even if the cover is supposed to be very stable and inflexible because of guide vanes, it is still subjected to relatively strong thermal stresses due to the coolant which can also be decoupled from the joint at the edge due to the relief grooves.

FIG. 4A shows a sectional view of the cover 20 with relief grooves 34 applied in the edge region which are disposed respectively on the inside and on the outside thereof. It is also possible to install the cover 20 of FIG. 4A the other way round, whereupon the relief groove 34 with the larger diameter is disposed outside on the valve disk and the relief groove 34 with the smaller diameter is disposed inside in the cavity. It is also possible to use an inner and an outer relief groove with respectively identical diameters.

FIG. 5 shows a valve in accordance with the invention with a cover with a relief groove and a conical structure 25 which serves to divert a coolant moving in the valve stem in the direction of the valve disk in the direction of the edge of the valve disk. By means of the conical structure, the impact force of the coolant on the cover is reduced and the joint between the cover and valve disk is relieved. In the embodiment shown, the conical structure is designed as a parabolic cone in order to guide the flowing coolant in the direction of the edge of the valve disk with as little spiking as possible. In the embodiment shown, the parabolic cone merges directly into the relief groove 34 in order to provide as smooth a flow as possible in the region of the valve disk. At the edge or at the outer flank of the relief groove, the direction of flow of the coolant is diverted upwardly so that the coolant in the cavity flows along the rear side of the valve disk. It is also possible to configure the outer flank of the relief groove and the cavity of the valve in a manner such that the flow of the coolant is diverted up and back so that the coolant in the cavity along the edge of the valve disk forms a vortex ring, at least until this region of the cavity is filled with coolant. The vortex ring then flows in a vortex in the plane of the valve axis.

FIG. 5A shows a sectional view of the cover 20 with the relief groove 34 applied in the edge region which flows into the conical structure 26 in the centre. A coolant flowing downwards in the centre from above will initially be guided outwards in the direction of the edge by the conical structure 26, and then will be guided into the relief groove 34. The outer edge of the relief groove 34 guides the coolant back again in the direction of the rear side of the valve disk. By means of the cooperation of the relief groove and the conical structure 26, both an improved service life of the joint between the cover and valve disk as well as an optimized flow in the cavity of the valve are obtained. By means of a smooth transition between the conical structure and a corresponding asymmetrical cross-section of the relief groove 34, better flow behaviour can be obtained than with a simple combination of a stream guide cone and a relief groove 34 alone.

FIG. 6 corresponds essentially to FIG. 5, wherein the cover 30 is provided with a further relief groove 34 on the disk face. In comparison with FIG. 5, this therefore results in a further increased elasticity of the cover and thus an enhanced relief of the joint.

FIG. 7 essentially corresponds to FIG. 5 or FIG. 6, wherein the cover 30 is provided with two further relief grooves 34 on the disk face. In comparison with FIGS. 5 and 6, this therefore results in a further increased elasticity of the cover and thus an enhanced relief of the joint.

FIG. 7A shows a sectional view of the cover of FIG. 7 on which the two outer relief grooves 34 and the inner relief groove 34 can clearly be seen. The smooth transition between the conical structure 26 and the inner relief groove can also clearly be seen. FIG. 7A also clearly shows that the inner relief groove is not symmetrical in construction. The outer flank of the inner relief groove 34 of FIG. 7A points inwards or is undercut and thus guides the coolant upwards and back in the direction of the valve axis.

FIG. 8 shows a section through a cover with a conical structure 26 which forms a smooth circular cone. The inner relief groove 34 here is disposed directly at the edge of the cover 20.

FIG. 9 shows a valve in accordance with the invention with a cover which essentially corresponds to that of FIG. 8. In addition, FIG. 9 shows the flow of the coolant in the cavity upon opening of the valve.

It should be clear that here, both inside and also outside, a plurality of relief grooves may be employed in order to increase the elasticity at the edge of the cover 20. It is also possible for all of the individual features of the figures to be combined to produce other embodiments; thus, for example, the guide vanes of the cover may be provided with corresponding helical guide vanes in the valve stem. It is also possible to combine one of the helical guide vanes in the valve stem with a cover which is provided with relief grooves 34. It is also possible to dispose a guide vane in the valve stem which makes a coolant move upwards in the direction of the valve stem end in a rotary flow around a valve axis. It is also possible for the helical guide vanes to terminate before an upper end of the valve stem in order to perturb a rotary flow close to the stem end as little as possible.

### REFERENCE LIST

2 internally cooled valve in accordance with the prior art
4 internally cooled valve in accordance with the invention
6 valve disk
8 valve stem
10 cavity
12 coolant
18 opening
20 cover
22 valve disk face
24 rear side of the valve disk
26 conical structure
32 joint
34 relief groove
36 stem end

1. A cooled valve for internal combustion engines, comprising
a valve disk,
a valve stem,
as well as a cavity within the valve stem and the valve disk, and
a coolant which is disposed in the cavity,
wherein the valve is in at least two parts and is provided with an opening on a valve disk face which is closed with a cover,
wherein the cover is additionally provided with at least one relief groove which relieves a joint between the opening of the valve disk face and the cover.

2. The cooled valve for internal combustion engines as set forth in claim 1, wherein the coolant is sodium.

3. The cooled valve for internal combustion engines as set forth in claim 1, wherein the at least one relief groove in the cover is disposed around a valve axis in a circle.

4. The cooled valve for internal combustion engines as set forth in claim 1, wherein the at least one relief groove is disposed on an inside of the cover in the cavity.

5. The cooled valve for internal combustion engines as set forth in claim 1, wherein the at least one relief groove is disposed on the outside of the cover.

6. The cooled valve for internal combustion engines as set forth in claim 5, wherein the cover comprises a conical structure in the centre in order to guide the coolant in the radial direction of the valve disk.

7. The cooled valve for internal combustion engines as set forth in claim 6, wherein the relief groove on an inner side merges directly into the conical structure in the centre.

8. The cooled valve for internal combustion engines as set forth in claim 7, wherein the relief groove has a cross-section which guides coolant which is flowing radially outwardly in the direction of a rear side of the valve disk.

9. The cooled valve for internal combustion engines as set forth in clam 1, wherein the depth of a relief groove is such that it corresponds to at least one third of the height of the cover and at most two thirds of the height of the cover.

10. The cooled valve for internal combustion engines as set forth in claim 1, wherein in the region of the at least one relief groove, the cover has a material thickness which is reduced by one quarter to three quarters, preferably one third to two thirds and more preferably by two fifths to three fifths.
